(19) United States
(12) Patent Application Publication
(10) Pub. No.: US 2025/0206524 A1
(43) Pub. Date: Jun. 26, 2025

(54) WASTE BIN CLEANING TRUCK

(71) Applicant: CLEAN WASTE MANUFACTURING, Las Vegas, NV (US)

(72) Inventor: Betsy AGANOWSKI, Las Vegas, NV (US)

(73) Assignee: CLEAN WASTE MANUFACTURING, Las Vegas, NV (US)

(21) Appl. No.: 18/990,704

(22) Filed: Dec. 20, 2024

Related U.S. Application Data
(60) Provisional application No. 63/612,420, filed on Dec. 20, 2023.

(51) Int. Cl. B65F 7/00; B08B 9/08; B08B 9/093; B60P 3/22; B65F 3/02; B65F 3/04; B65F 3/18

(52) U.S. Cl. CPC B65F 7/005; B08B 9/0826; B08B 9/093; B60P 3/2245; B65F 3/041; B65F 3/18; B08B 2209/08; B65F 2003/023

(57) ABSTRACT

A vehicle mounted apparatus for cleaning a waste container includes a movable carriage assembly that grasps a waste bin and inverts the waste bin over an air nozzle to discharge waste into a waste compartment, and inverts the waste bin over a spray head that washes down the interior of the bin.

### CROSS-REFERENCE TO RELATED APPLICATIONS

This application claims priority in U.S. Patent Application Ser. No. 63/612,420, filed Dec. 20, 2023, the contents of which are hereby incorporated by reference.

### BACKGROUND

### 1. Field of the Disclosed Subject Matter

Waste collection.

### 2. Background

Waste bins are used for collecting refuse, such as landfill garbage, food waste, recyclables, and yard waste. There is a need for an efficient emptying and cleaning of residential and commercial waste bins located at the curbside.

### SUMMARY

A truck capable of both accepting waste from a waste bin and holding the waste until disposal, and cleaning the waste bin has a lifting assembly that can be operated from the cab, whereby the waste bin is inverted to empty the bin, followed by a high-pressure wash. The truck can be powered by fossil fuels or by battery. A waste bin cleaning truck can be dedicated to handling waste bins containing a specific type of refuse, such as food waste, to allow compliance with regulations requiring the separate collection and disposal of such refuse.

### BRIEF DESCRIPTION OF THE DRAWINGS

The present disclosed subject matter is described herein with reference to the following drawing figures, with greater emphasis being placed on clarity rather than scale:

FIG. 1 is a perspective view of a waste bin cleaning truck system of the disclosed subject matter with a waste bin positioned above the air nozzle.

FIG. 2 is a perspective view of a waste bin cleaning truck system of the disclosed subject matter.

FIG. 3 is an enlarged view from above of the lifting assembly and wash assembly of the disclosed subject matter.

FIG. 4 is a section view along line 4-4 in FIG. 2 of the baste bin cleaning truck system.

FIG. 5 is an enlarged view from above of the wash assembly of the disclosed subject matter.

FIG. 6 is an enlarged perspective view of the lifting assembly of the disclosed subject matter.

FIG. 7 is a view of the lifting assembly of the disclosed subject matter.

FIG. 8 is a view of the griper arms of the disclosed subject matter.

FIG. 9 is a view of the griper arms of the disclosed subject matter.

### DETAILED DESCRIPTION

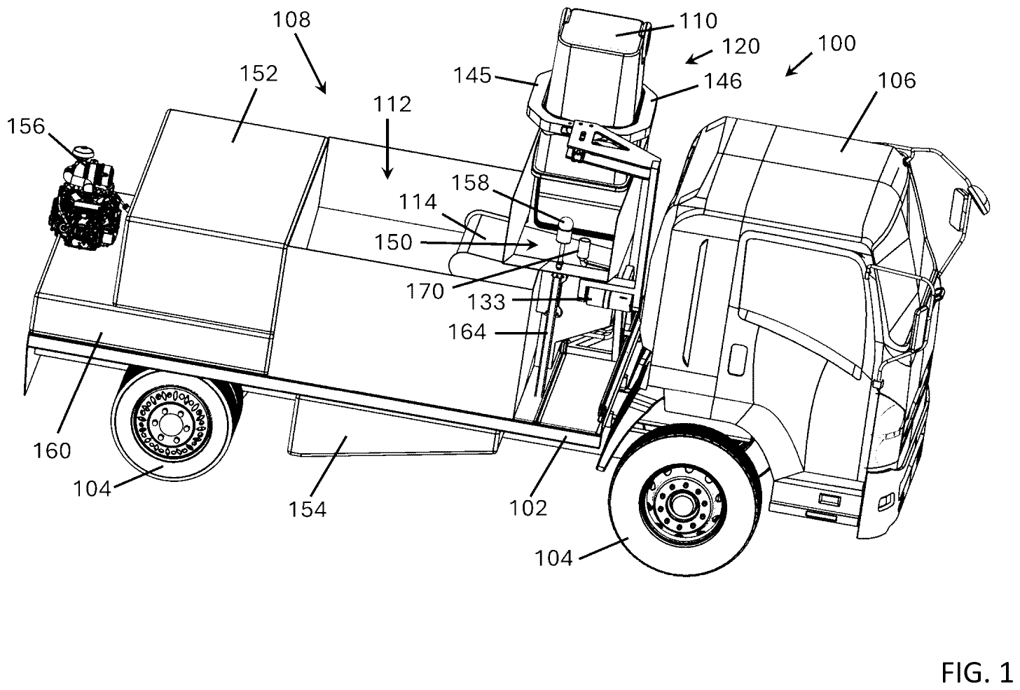

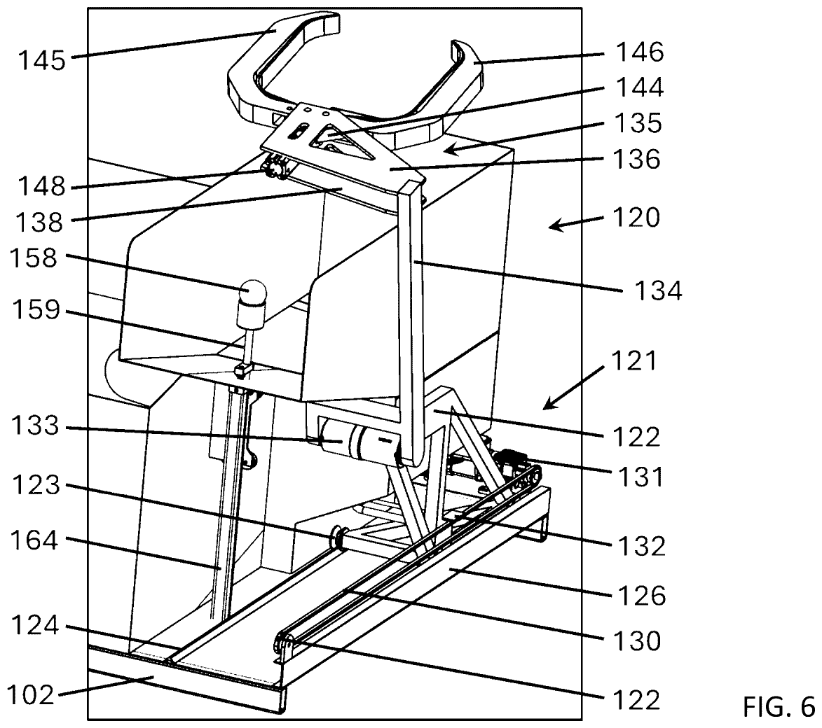

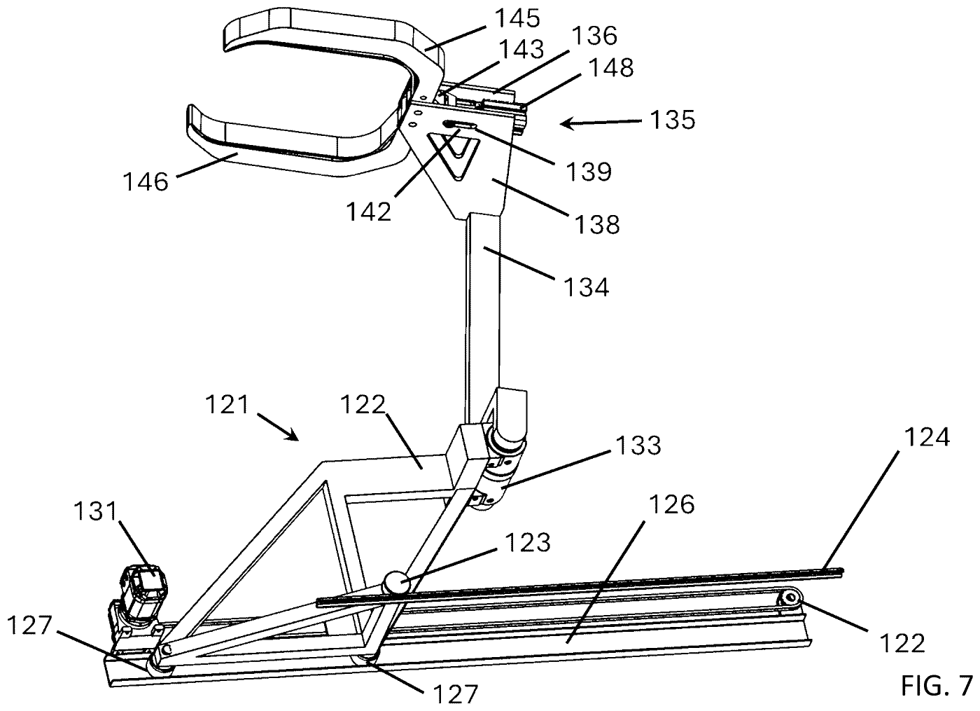

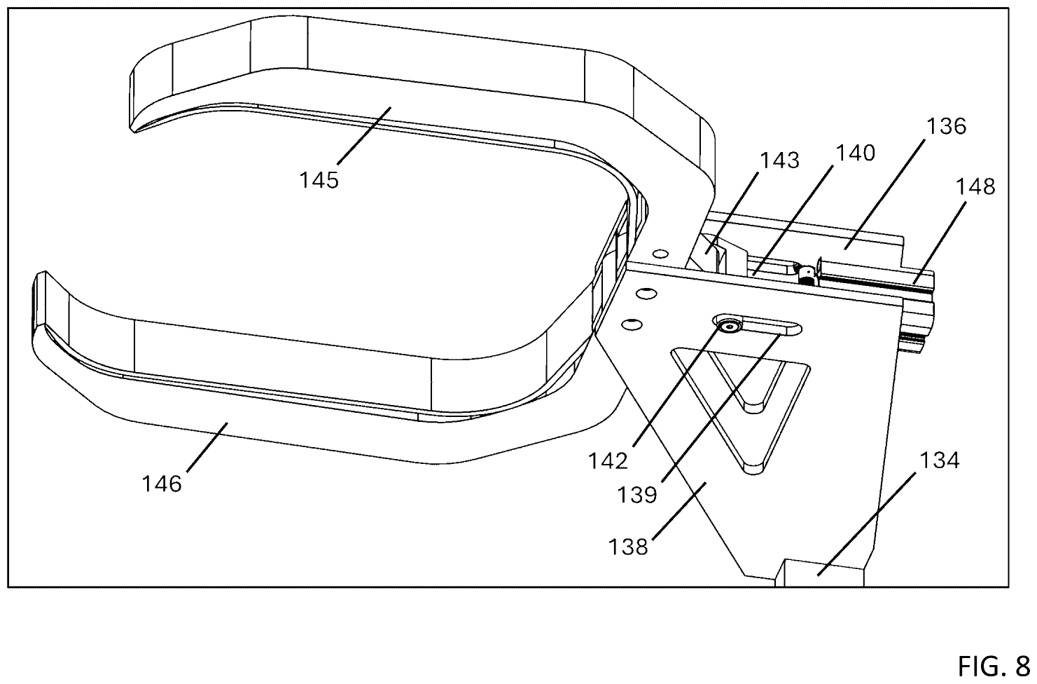

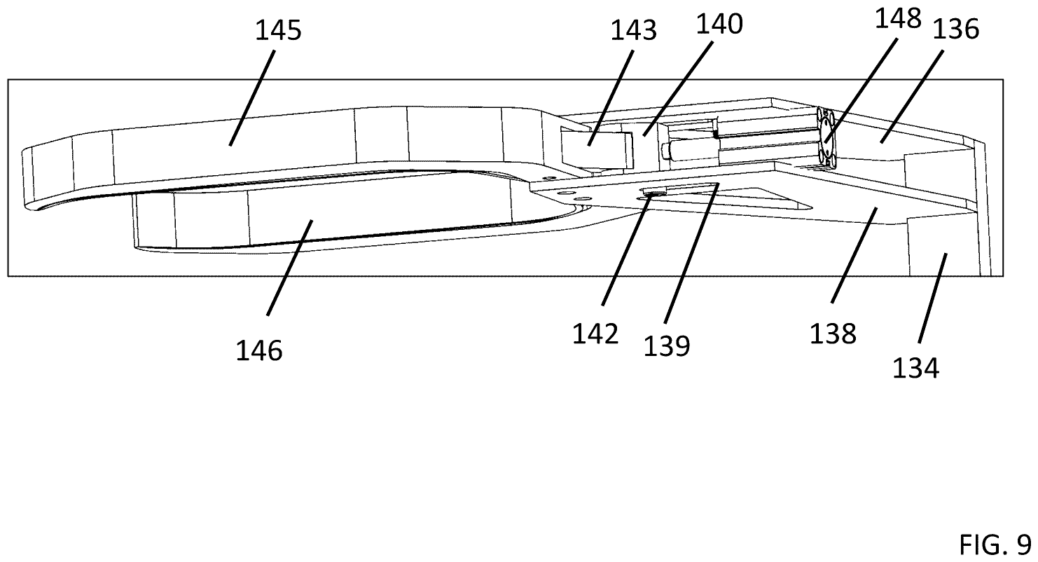

An embodiment of a waste container or waste bin cleaning truck 100 and system is shown in FIGS. 1-9. The truck 100 includes ground engaging wheels 104 connected to a vehicle bed or frame 102, with a cab 106 at the front, and a bed assembly 108 at the rear. The truck 100 is used to empty the contents of a waste container or bin 110, and clean the waste bin 110 following the dumping of the contents. In an implementation, the system is used to clean a waste bin 110 that has been emptied of contents.

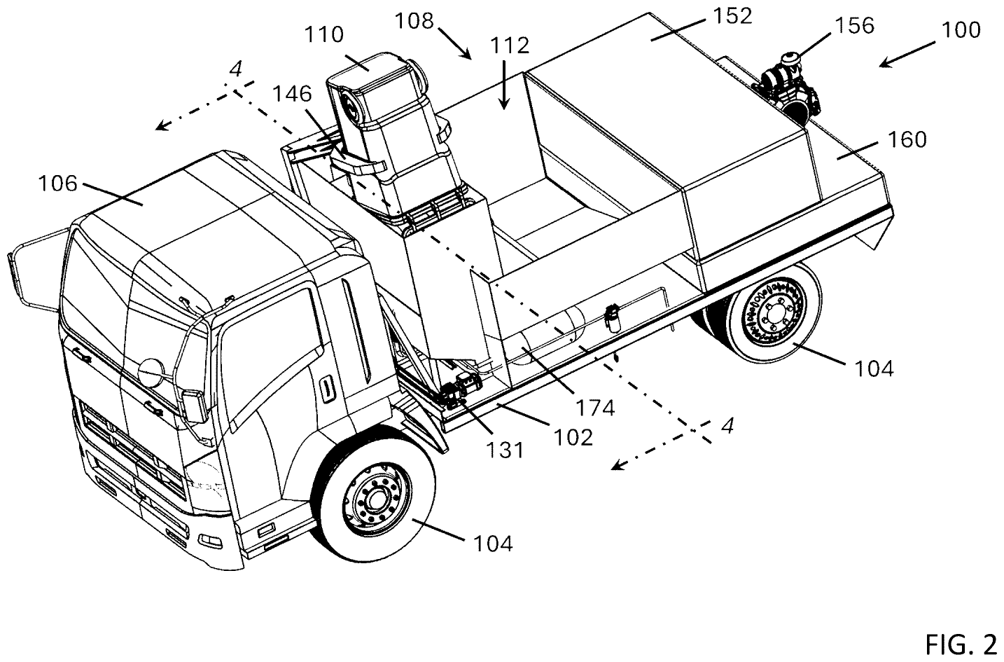

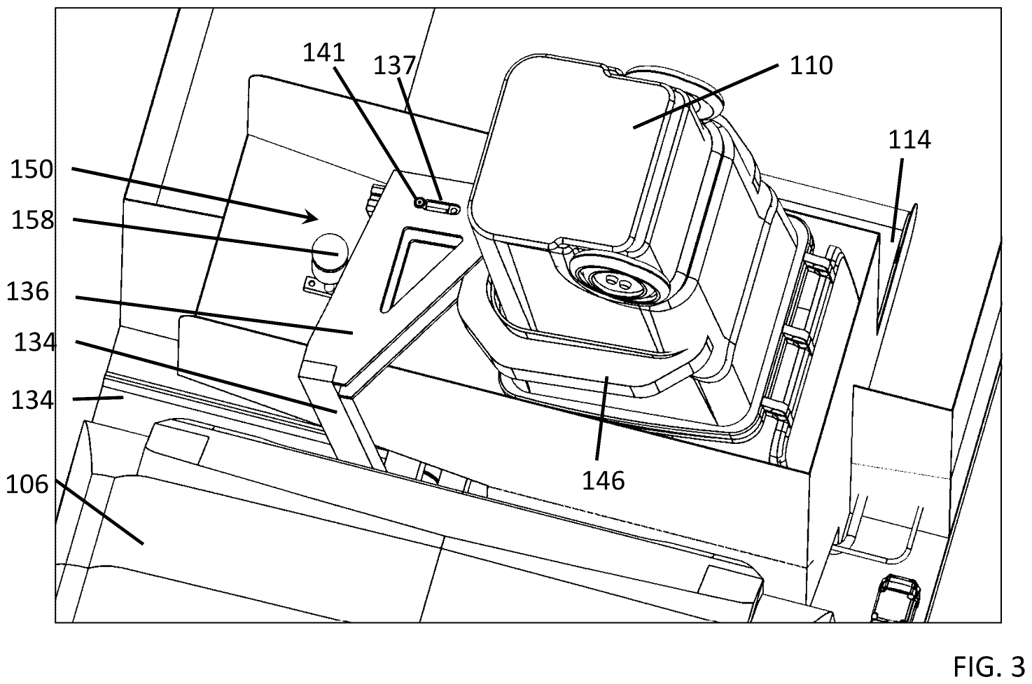

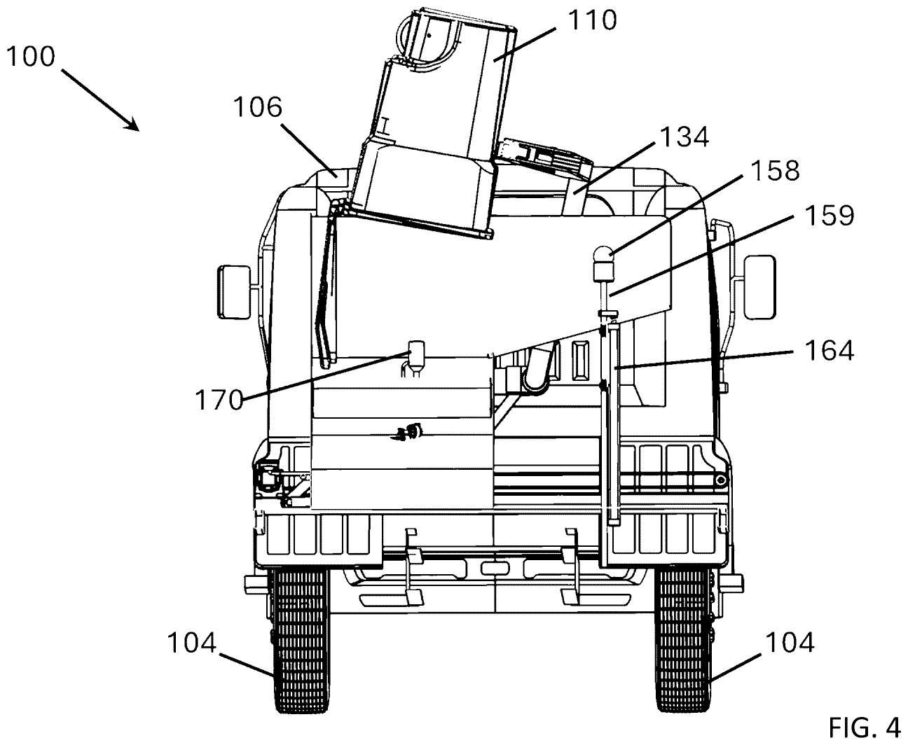

The system includes a bed assembly 108 with a waste compartment 112 for receiving the contents of the waste bin 110, an air assembly 168 for blowing contents and debris from the waste bin 110, and an adjacent wash assembly 150 for cleaning the waste bin 110. In operation, an operator positions the truck 100 adjacent a waste bin 110. Referring to FIGS. 1-2, the operator, from the cab 106, initiates a waste bin 110 capturing step by directing the lifting assembly 120 to extend from the side of the bed assembly 108 to capture the waste bin 110 between a capture assembly consisting of a first movable gripper arm 145 and a second movable gripper arm 146 and perform a lifting operation. Next, the lifting operation begins by the lifting assembly 120 first raising the bin 110 from the ground followed by the waste emptying step whereby the lifting assembly 120 moves the bin 110 adjacent the waste compartment 112 with the bin 110 inverted over the air assembly 168 to blow away remaining waste or debris from the bin 110 (FIGS. 3-4). The blown material settles on a mesh conveyor 114, and the mesh conveyor moves the material rearward to the waste compartment 112 where the material remains until discarded.

Next, the lifting assembly 120 then positions the empty, inverted waste bin 110 over a wash assembly 150 for the washing step whereby a sprayer assembly with a sprayer 158 directs pressurized fluid into the interior of the waste bin 110 to wash the bin and rinse residue left from the contents into a wash receptacle that drains to the mesh conveyor 114 and into the waste compartment 112. The lifting operation concludes with the release step whereby the lifting assembly 120 places the waste bin 110 upright on the ground, empty of waste, and cleaned of residue. The lifting assembly 120 is then stowed with the truck 100. The operator then positions the truck 100 adjacent a next waste bin 110 and the process is repeated to empty and clean waste bins 110.

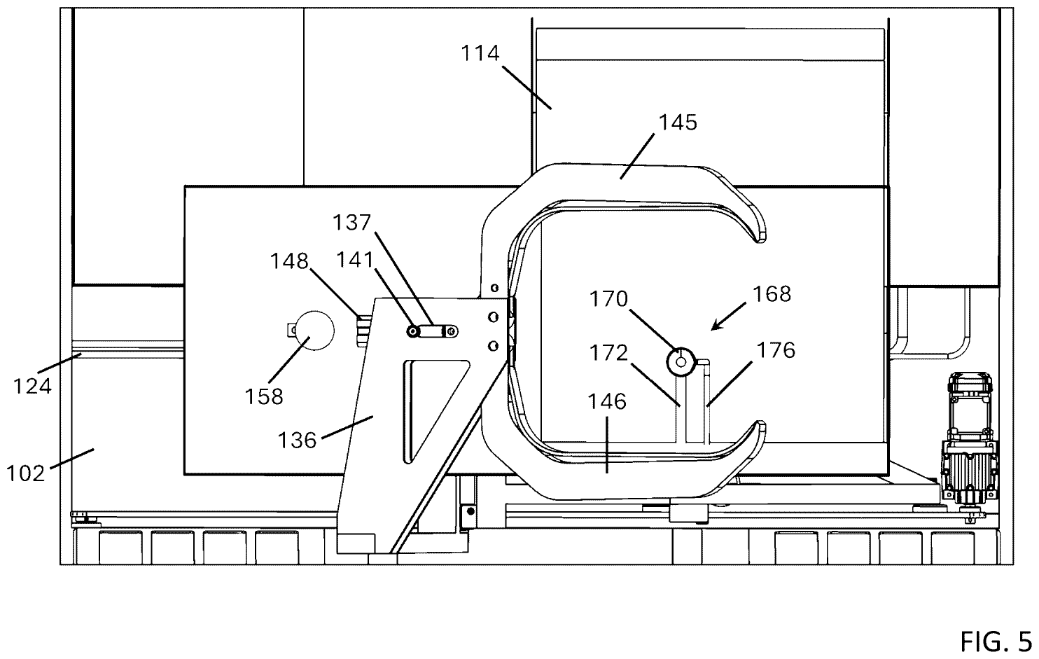

Referring to FIGS. 5-9, the lifting assembly 120 includes a carriage assembly 121 pivotally attached to an arm 134. A first gripper arm 145 and opposing second gripper arm 146 for gripping a waste bin 110 are attached to the arm 134 by a pivot plate assembly 135. The carriage assembly 121 includes a frame 122 with a track roller 123 that engages a track 124, and wheels 127 that engage a captive rail 126, allowing the lifting assembly 120 to move transversely on the bed frame 102 to position the lifting assembly 120 in a position to lift a waste bin 110 from the ground, and position an inverted waste bin 110 above the wash assembly 150 and air assembly 168. An upper portion of the frame 122 includes an actuator 133 for moving the arm 134 between a position whereby the gripper arms capture and release a bin 110 on the ground, and a position whereby the bin 110 is inverted exposing the interior of the bin 110. In an implementation the actuator is a rotary actuator. The arm 134 extends from the actuator 133 at a first end to the pivot plate assembly 135 at a second end.

In an implementation, the carriage assembly 121 is moved along the track 124 and captive rail 126 by a motor 131. The motor 131 is operably connected to the carriage assembly 121 by a chain connected to the frame 122 by a chain bracket, and a pulley 129 connected to the captive rail 126 opposite the motor 131.

The pivot plate assembly 135 includes a fist plate 136 and opposing second plate 138. An actuator, such as a hydraulic cylinder 148, connected to the pivot plate assembly 135 is operably connected to the first gripper arm 145 and second gripper arm 146. In an implementation, the hydraulic cylinder 148 is connected to the gripper arms via a yoke 140 through a first link 143 connected to the first gripper arm 145 and a second link 144 connected to the second gripper arm 146. The hydraulic cylinder 148 is connected to the hydraulic pump and control system of the truck 100. The hydraulic cylinder 148 rod extends from the barrel moving the gripper arms 145, 146 apart, and the rod is retracted into the barrel moving the gripper arms together. Alignment of the rod is aided by a first guide roller 141 attached to the hydraulic cylinder 138 that moves within a first guide 137 in the first plate 136, and a second guide roller 141 attached to the hydraulic cylinder 138 that moves within a second guide 139 in the second plate 138.

The air assembly 168 includes an air nozzle 170 positioned above the mesh conveyor 114. A conduit 172 feeds air to the nozzle 170 from a compressor tank 174, and the nozzle 170 discharges air upward into the inverted waste bin 110 to loosen and discharge debris from the interior of the waste bin 110 onto the mesh conveyor 114. In an implementation, a water conduit 176 feed water into the airstream of the nozzle 170 to introduce liquid into the waste bin 110.

The wash assembly 150 includes a sprayer nozzle 158 connected to the water tank 152 by a conduit 159. In an implementation the air nozzle 170 is adjacent the sprayer nozzle 158. A pump 156 moves water from the water tank 152 to the sprayer nozzle. An air cylinder 164 fed by an air supply moves the sprayer nozzle 158 upward into the interior of the inverted waste bin 110 to discharge pressurized water and detergent into the bin 110 for cleaning the bin. A detergent tank 154 supplies detergent to the wash assembly 150 to aid in cleaning the waste bin 110. Liquid that drains from the waste bin 110 is collected in a holding tank 160.

In an implementation, a heater heats the fluid provided to the sprayer 158. The pump 156 provides pressurized fluid to the sprayer 158, and moves the wash and rinse residue from the wash receptacle to the holding tank 160. Some grey water in the holding tank 160 is filtered through a filtration system to clean the water for reuse by the sprayer 158, resulting in a conservation of water by the waste bin cleaning system.

In an implementation, the system includes a drying step after the washing step and the release step. The drying step uses the air assembly 168 to introduce air into the inverted waste bin 110 to induce the liquid remaining in the waste bin 110 to drain out of the top of the waste bin 110. Pressurized air exits the air nozzle 170 as it moves from the bottom of the waste bin 110 toward the opening of the waste bin 110, moving liquid toward the opening of the waste bin to allow the liquid to exit the waste bin. In an implementation, the air nozzle is on the spray assembly and may include an air nozzle cover to prevent liquid from entering the drying assembly.

The system may use one or more light sources at the exterior of the truck 100 to provide illumination, or that illuminate various areas within the truck 100, such as the waste compartment 112, wash assembly 150, holding tank 160 area, etc.

The system can be used with waste bins 110 used for a variety of waste disposal functions, and collects and stores a variety of waste, such as landfill garbage, recycling materials, food waste, and yard waste. The waste debris and material removed from the bins 110 is stored on the truck 100 and accumulates in the waste compartment 112 as the truck empties waste bins 110 and cleans waste bins 110 for reuse. The waste compartment 112 is separate from the holding tank 160 that accumulates the grey water. The truck 100 and system can be powered using a variety of sources, such as batteries, or fossil fuels.

1. An apparatus for cleaning a waste container, comprising:
a lifting assembly, comprising:
a carriage assembly movable about a vehicle frame;
an arm pivotally connected to the carriage assembly; and
a capture assembly connected to the arm for capturing the waste container;
an air assembly, comprising:
an air nozzle for discharging air into the waste container;
a wash assembly, comprising:
a sprayer that directs fluid into the waste container.

2. The apparatus of claim 1, further comprising:
wherein the capture assembly comprises:
a first movable arm and an opposing second movable arm; and
wherein the first movable arm and second movable arm capture the waste container.

3. The apparatus of claim 2, further comprising:
wherein the capture assembly further comprises:
an actuator operably connected to the first movable arm and second movable arm for moving the arms into engagement with waste container.

4. The apparatus of claim 1, further comprising:
wherein the wash assembly further includes an air cylinder for raising and lowering the sprayer.

5. The apparatus of claim 1, further comprising:
wherein the air nozzle is located adjacent the sprayer.

6. The apparatus of claim 1, further comprising:
a waste compartment;
a mesh conveyor disposed below the air nozzle, whereby the air discharged from the air nozzle transfers debris from the waste container onto the mesh conveyor, and the mesh conveyor moves the debris into the waste compartment.

7. The apparatus of claim 1, further comprising:
a holding tank for collecting the fluid.

8. The apparatus of claim 7, further comprising:
wherein the holding tank provides fluid to the sprayer.

9. An apparatus for cleaning a waste container, comprising:
a vehicle, comprising:
a water tank; and
a waste compartment;
a lifting assembly, comprising:
a carriage assembly movable about the frame along a track;
an arm pivotally connected to the carriage assembly; and
a capture assembly connected to the arm for capturing the waste container;
an air assembly, comprising:
an air nozzle for discharging air into the waste container; and
a wash assembly, comprising:
a sprayer that directs fluid into the waste container.

10. The apparatus of claim 9, further comprising:
wherein the lifting assembly inverts the waste container above the air assembly.

11. The apparatus of claim 9, further comprising:
wherein the lifting assembly inverts the waste container above the wash assembly.

12. The apparatus of claim 11, further comprising:
wherein the wash assembly further includes an air cylinder for raising and lowering the sprayer into the waste container.

13. An apparatus for cleaning a waste container, comprising:
a vehicle, comprising:
a frame;
a water tank connected to the frame;
a detergent tank connected to the frame; and
a waste compartment connected to the frame;
a lifting assembly, comprising:
a carriage assembly movable about the frame along a track;
an arm pivotally connected to the carriage assembly by a rotary actuator; and
a capture assembly connected to the arm for capturing the waste container;
an air assembly, comprising:
an air nozzle for discharging air into the waste container; and
an air tank supplying air to the air nozzle;
a wash assembly, comprising:
a sprayer that directs fluid into the waste container.

14. The apparatus of claim 13, further comprising:
wherein the capture assembly comprises:
a first movable arm and an opposing second movable arm; and
wherein the first movable arm and second movable arm capture the waste container.

15. The apparatus of claim 14, further comprising:
wherein the capture assembly further comprises:
a yoke operably connected to the first movable arm and second movable arm;
an actuator operably connected to the yoke for moving the arms into engagement with waste container.

16. The apparatus of claim 13, further comprising:
wherein the wash assembly includes:
an air cylinder for raising and lowering the sprayer; and
wherein the air tank provides air to the air cylinder.

17. The apparatus of claim 13, further comprising:
wherein the air nozzle is disposed adjacent the sprayer.

18. The apparatus of claim 13, further comprising:
a waste compartment;
a mesh conveyor disposed below the air nozzle, whereby the air discharged from the air nozzle transfers debris from the waste container onto the mesh conveyor, and the mesh conveyor moves the debris into the waste compartment.

19. The apparatus of claim 13, further comprising:
a holding tank connected to the frame for collecting the fluid from the waste compartment; and
wherein the holding tank provides fluid to the sprayer.
